(19) United States
(12) Patent Application Publication
(10) Pub. No.: US 2018/0298287 A1
(43) Pub. Date: Oct. 18, 2018

(54) OPTIMIZATION OF OIL SANDS EXTRACTION BASED ON ORE SOLIDS HYDROPHOBICITY

(71) Applicant: SYNCRUDE CANADA LTD. in trust for the owners of the Syncrude Project as such owners exist now and, Fort McMurray (CA)

(72) Inventors: JUN LONG, Edmonton (CA); SHANE HOSKINS, Edmonton (CA)

(21) Appl. No.: 15/891,228

(22) Filed: Feb. 7, 2018

Related U.S. Application Data
(60) Provisional application No. 62/456,398, filed on Feb. 8, 2017.

(51) Int. Cl. C10G 1/04; G01N 15/08

(52) U.S. Cl. CPC C10G 1/047; G01N 15/08

(57) ABSTRACT

In one aspect, a method of optimizing bitumen extraction from mined oil sand ores, using a process having one or more process variables which affect bitumen recovery and/or bitumen froth quality is provided comprising measuring a measure of hydrophobicity of the solids in the ore; and adjusting the one or more process variables in response to the measure of hydrophobicity to increase bitumen recovery and/or improve bitumen froth quality by increasing its bitumen content and/or reducing its solids content.

### FIELD OF THE INVENTION

The present invention relates to a method for optimizing bitumen recovery in an oil sands extraction process, by measuring ore solids hydrophobicity.

### BACKGROUND

Water-based oil sand extraction processes are widely used to recover bitumen from mined oil sands. These processes typically includes steps of: preparing a slurry from mined oil sand by mixing it with water, conditioning the slurry, and separating the slurry to recover the bitumen. To help bitumen separation, caustic (NaOH) is often used as an extraction process aid. For a given feed, a few measures can be used in commercial operations to optimize bitumen extraction performance, including the control of caustic addition based on the feed grade and/or fines content, the adjustment of feed rate based on feed quality (lowing rates for poor feed), the control of water addition to have desirable densities for processing streams, and increasing temperatures.

Currently, ore blending is controlled to achieve desirable feed grade and fine content. For a given feed, ore grade and/or fines content are used to control such parameters as caustic dosage, feed rate, water addition, and temperature for optimizing bitumen extraction performance.

However, it is well known that ore processability is not only controlled by grade and fines content. For example, a low-grade feed may not have a poor processability and thus may not necessarily need a high dosage of caustic to achieve an acceptable bitumen recovery. As a result, the existing control measures mainly based on ore grade and fines content are not always able to optimize the extraction processes.

### SUMMARY OF THE INVENTION

The present invention relates to the observation that the interaction between bitumen and solids is related to solids hydrophobicity, and therefore a measure of solids hydrophobicity may be used to control one or more process variables of a water-based bitumen extraction process. The present invention may be used in combination with a consideration of ore grade and fines content, in an effort to optimize bitumen extraction from oil sands.

In one aspect, a method of optimizing bitumen extraction from mined oil sand ores, using a process having one or more process variables which affect bitumen recovery and/or bitumen froth quality is provided, the method comprising the steps of:
measuring a measure of hydrophobicity of the solids in the ore; and
adjusting the one or more process variables in response to the measure of hydrophobicity to increase bitumen recovery and/or improve bitumen froth quality by increasing its bitumen content and/or reducing its solids content.

In one embodiment, the method further comprises:
measuring ore grade, fines content, or both, of the ore and adjusting the one or more process variables in response to the measure of hydrophobicity and one or both of ore grade and fines content.

### BRIEF DESCRIPTION OF THE DRAWINGS

The attached or enclosed drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows the average Critical Surface Tension of an oil sand solids sample as determined by the Thin Film Flotation Technique.

### DETAILED DESCRIPTION

As used herein, the recited terms have the following meanings. All other terms and phrases used in this specification have their ordinary meanings as one of skill in the art would understand.

To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The key characteristic of Alberta oil sands that makes bitumen economically recoverable is that the sand grains are hydrophilic and encapsulated by a water film which is then covered by bitumen. The water film prevents the bitumen to be in direct contact with the sand and, thus, by slurrying mined oil sand with heated water, the bitumen is allowed to be liberated from the sand grains and move to the aqueous phase. Even though the sand grains encapsulated by a water film are hydrophilic, there are always some hydrophobic solids in the oil sands. Also, some hydrophilic solids could become hydrophobic after they were in direct contact with bitumen. As bitumen is hydrophobic by nature, it is very difficult to separate bitumen from hydrophobic solids. A high content of hydrophobic solids in the oil sand could lead to poor bitumen recovery and high froth solids content.

The present invention relates generally to an optimized water-based process of extracting bitumen from mined oil sand ores by adjusting a process variable based on a measure of hydrophobicity of the solids in the ore. In one embodiment, a measure of hydrophobicity of the solids in the oil sand is used in combination with the ore grade and fines content, to control the oil sand extraction process in an effort to optimize its overall performance.

As used herein, “ore grade” means the weight percent (wt %) bitumen in oil sand ore. As used herein, “fines content” means the weight percent (wt %) of particles less than 44 μm in any dimension present in oil sand ore.

In one embodiment, the measure of hydrophobicity is the average solids critical surface tension of a sample. Other measures of hydrophobicity may include water contact angle, water penetrating time, partitioning percentage, partial molar heat capacity, transition temperature and other measures known to those skilled in the art. Any of these measures may be measured by any suitable method known to those skilled in the art.

In one embodiment of the process of the present invention useful in extracting bitumen from oil sand ores, oil sand is mined from an oil sand rich area such as the Athabasca Region of Alberta. The oil sand ore may comprise a fines content up to about 60% by weight and a bitumen content greater than about 6% by weight. “Fines” are particles such as fine quartz and other heavy minerals, colloidal clay or silt generally having any dimension less than about 44 μm. There exists an abundance of “poor processing ores” which alone yield poor bitumen recovery and consequently cannot be processed unless a high proportion of good processing ores are blended into these dry ore feeds. “Poor processing ores” are oil sand ores generally having low processability (low bitumen recovery and/or poor froth quality under normal operation conditions). Most ores having low bitumen content (about 6 to about 10%) and/or high fines content (greater than about 30%) are poor processing ore. In comparison, “good processing ores” are oil sand ores generally having high processability (high bitumen recovery and good froth quality under normal operation conditions). Most ores having high bitumen content (about 10 to about 12% or higher) and/or low fines content (less than about 20%) are good processing ores.

In general terms, the process includes the following steps. The oil sand is mixed with heated water in a slurry preparation unit. The slurry preparation unit may comprise a tumbler, screening device and pump box; however, it is understood that any slurry preparation unit known in the art can be used. In addition to the oil sand and water, caustic (sodium hydroxide) is also added to the slurry preparation unit to aid in conditioning the oil sand slurry. The caustic may be added to the water prior to mixing with oil sand, directly into the slurry preparation unit during mixing, or to the oil sand slurry prepared prior to hydrotransport/slurry conditioning. Preferably, the caustic is added to the heated water.

Following the addition of caustic, the oil sand slurry may be screened through a screen portion, where additional water may be added to clean the rejects (e.g., oversized rocks) prior to delivering the rejects to a rejects pile. The screened oil sand slurry is collected in a vessel such as a pump box where the oil sand slurry is then pumped through a hydrotransport pipeline (slurry conditioning), which is of an adequate length to ensure sufficient conditioning of the oil sand slurry, e.g., thorough digestion/ablation/dispersion of the larger oil sand lumps, coalescence of released bitumen flecks and aeration of the coalesced bitumen droplets.

The conditioned oil sand slurry is then fed to a bitumen separation vessel (also referred to as a primary separation vessel or PSV), which operates under somewhat quiescent conditions to allow the bitumen droplets to rise to the top of the vessel and form bitumen froth. The froth overflows to the launder and is collected for further froth treatment. The tailings from the PSV are either discarded or further treated for additional bitumen recovery. Middlings which remain suspended in the middle of the PSV are fed to secondary separation devices such as a bank of flotation cells or a tails oil recovery vessel (TORV) to recover additional bitumen.

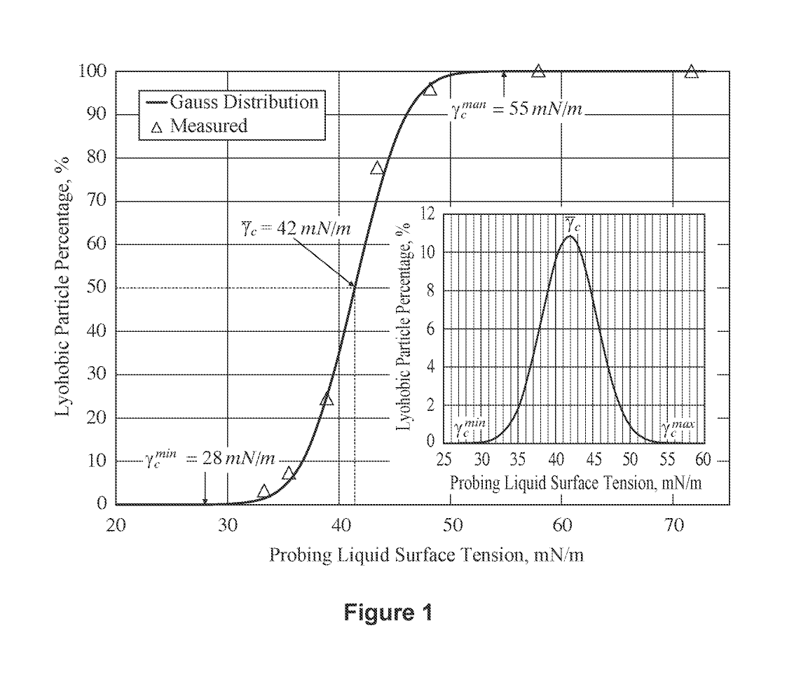

In one embodiment, the measure of solids hydrophobicity can be measured online, inline, offline, or at line, at any suitable point in the process. For example, the thin film flotation technique may be used to measure an average solids hydrophobicity by measuring the critical surface tension distribution of fine solid particles [1]. The cumulative percentage of lyophobic particles that stay on the surface is plotted as a function of probing liquid surface tension. FIG. 1 shows an example of the results obtained with a solids sample extracted from an oil sand ore.

An average critical wetting surface tension can be defined, obtained, and used to represent the average surface hydrophobicity of the particles as shown in FIG. 1. The red curve in FIG. 1 is the best fitted accumulative Gauss distribution for the measured data points whereas the inset in FIG. 1 is the corresponding Gauss frequency distribution. From this figure, the values of the mean (Y̅_{c}), minimum (γhd c^{min}) and maximum (γ_{c}^{max}) critical surface tensions as well as the standard deviation (94 _{γc}) of the sample can all be obtained. For this specific example, these values are 42, 28, 55, 3.7 mN/m, respectively. The minimum (γ_{c}^{min}), and maximum (γ_{c}^{max}) critical surface tensions represent the critical surface tensions of complete wetting and complete non-wetting, respectively. The distribution as shown in the inset of FIG. 1 represents the hydrophobicity distribution of the particles in the sample tested.

Once the average solids hydrophobicity of a sample is known, the extraction process variable to be controlled can be any process parameter which affects any process variable, such as target of ores for blending, blending ratio, caustic dosage, water addition, processing temperature, or combinations thereof. The process adjustment may be any suitable process adjustment, of which various non limiting examples are provided below.

Ore and slurry preparation variables may include blending of ores from different parts of a mine, mass of water added to form a hydrotransport slurry, temperature of water to form a hydrotransport slurry, mass of caustic added to a slurry, and mass of another additive added to a slurry. Primary separation vessel variables may include slurry dilution water rate and temperature, underwash flow rate and temperature, middlings withdrawal rate, middlings displacement rate (re-injecting flotation tailings into PSV), and additive injection rate into PSV. Tailings treatment variable may include blending ratio of multiple tailings streams ahead of subsequent treatment, flocculant type, flocculant addition rate, addition rate of another chemical (e.g. a coagulant), thickener operating parameters (e.g. feedwell dilution, rake speed, or residence time), in-line flocculant operating parameters (e.g. dynamic mixer speed), and a decision about whether to by-pass tailings treatment process (if tailings materials are determined to be off-specification).

In one embodiment, the measure of hydrophobicity is used to control the amount of caustic used in slurry preparation and/or temperature of the PSV. Caustic is used in bitumen extraction to improve bitumen recovery and froth quality as it promotes the release of natural surfactants from bitumen to the aqueous phase, precipitates divalent cations such as calcium and magnesium, modifies the electrical surface potentials of bitumen and solids, adjusts the slurry pH, leading to better bitumen-solids separation. For an oil sand ore, there is normally an optimal caustic dosage at which the highest bitumen recovery can be obtained and the optimal dosage appears to be determined by both the fines content (Sanford, E., 1983, Can. J. Chem. Eng. 61:554-567) and the ore grade. Increased temperature typically results in better bitumen extraction, with the penalty of greater energy input.

### EXAMPLE 1

Table 1 shows the results of batch extraction tests for two selected oil sands. Also included in this table is the ore quality information, including the grade, fines content (% <44 μm), and the solids average critical surface tension. Based on the ore grade and fines content, oil sand #1 should have lower recovery and poorer froth quality than oil sand #2. However, the results show the opposite. The relatively higher grade and lower-fines ore (#2) had a lower recovery and a much higher froth solids content. For these two oil sands, the solids hydrophobicity played a critical role in controlling their processability. Ore #2 had a lower average critical surface tension than ore #1, indicating that its solids were more hydrophobic, which led to poorer recovery and higher froth solids content. This example shows the importance of taking solids hydrophobicity into account when controlling the extraction process.

TABLE 1

| Oil Sand Information | | | | | |
|---|---|---|---|---|---|
| | | | Solids Average | Batch Extraction Test Results | |
| | | Fines, | Critical Surface | Primary | Primary Froth |
| | Grade, | % < | Tension, | Recovery, | Solids Content, |
| ID | % | 44 μm | mN/m) | % | % |
| #1 | 11.5 | 46.6 | 56.9 (more | 92.6 | 15.4 |
| | | | hydrophilic) | | |
| #2 | 12.1 | 20.6 | 44.7 (more | 88.0 | 29.4 |
| | | | hydrophobic) | | |

In this example, increasing temperature may improve the processability of ore #2.

### EXAMPLE 2

In this example, bitumen was extracted from three different oil sand ores using a normal water-based low energy extraction (LEE) process where the oil sand slurry temperature was maintained at 45° C. during slurry hydrotransport (oil sand slurry conditioning) and at 35° C. for bitumen flotation in a primary separation vessel (PSV). Caustic (NaOH) was added as the process aid at a concentration of 0.01%. Table 2 shows the properties of the three oil sand ores, #1, #2, and #3. It is understood that grade (wt % bitumen), fines content (wt % <44 μm) and d50 (average particle size, 982 m) can be determined by various means known in the art. For example, bitumen content can be determined by Dean-Stark extraction and particle size distribution to determine the % <44 μm and d50 can be performed using laser diffraction, Coulter counter, instrumental neutron activation analysis (INAA), sieve analysis, and the like.

TABLE 2

| | Oil Sand | Oil Sand | Oil Sand | Oil Sand |
|---|---|---|---|---|
| | Ore #1 | Ore #2 | Ore #3 | Ore #4 |
| Grade, wt % | 9.5 | 9.5 | 10.9 | 10.9 |
| bitumen | | | | |
| Fines content, | 25 | 25 | 20 | 20 |
| wt % < 44 μm | | | | |
| d₅₀, μm | 246 | 246 | 131 | 131 |
| Solids mean | 48 | 34 | 50 | 36 |
| critical surface | (hydro- | (hydro- | (hydro- | (hydro- |
| tension, mN/m | philic) | phobic) | philic) | phobic) |

Under normal LEE conditions, the ores containing mainly hydrophilic solids, namely, #1 and #3, resulted in high overall bitumen recovery, namely, 95 wt % and 93 wt %, respectively. However, ores #2 and #4 containing mainly hydrophobic solids both resulted in 0 wt % overall bitumen recovery under normal LEE conditions.

Oil sand ores #2 and #4 were then extracted under the normal LEE conditions with the addition of a high dosage of a process aid, namely, 0.16% sodium citrate to #2 and 0.1% caustic to #4. Under these conditions, the overall bitumen recovery was substantially increased for both #2 and #4, i.e. 67 wt % and 41 wt %, respectively. Extraction was further performed on oil sand ore #2 and #4 using both higher extraction temperatures, i.e., 50° C. during slurry hydrotransport and at 50° C. for bitumen flotation, and a high dosage of a process aid. Added to #2 was 0.1% sodium triphosphate and added to #4 was 0.1% caustic. Under these conditions, overall bitumen recovery from #2 and #4 increased to 88 wt % and 94 wt %, respectively.

It is interesting to note that oil sand ore #1 and oil sand ore #2 are exactly the same grade (9.5) and have exactly the same fines content (25) and d50 (246). Thus, without knowing the hydrophobicity of the oil sand ores, a person or ordinary skill would assume that overall bitumen recovery would be identical. This is clearly not the case, as oil sand ore #1 has an overall recovery of 95% whereas oil sand ore #2 had an overall bitumen recovery of 0%. Thus, knowing the hydrophobicity of an oil sand ore will allow for adjustments to either process aid selection, process aid dosage and/or extraction temperature.

Similarly, sand ore #3 and oil sand ore #4 are exactly the same grade (10.9) and have exactly the same fines content (20) and d50 (131). However, under normal LEE conditions, oil sand ore #3 had an overall recovery of 93% whereas oil sand ore #4 had an overall bitumen recovery of 0%. Thus, knowing the hydrophobicity of an oil sand ore will allow for adjustments to either process aid selection, process aid dosage and/or extraction temperature.

### Definitions and Interpretation

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

### REFERENCES

The following references are incorporated herein by reference, where permitted, and are indicative of the level of skill in the art.

[1] Willians, M., Fuerstenau, D., “A Simple Flotation Method for Rapidly Assessing the Hydrophobicity of Coal Particle”, International Journal of Mineral Processing, 20, 153-157, 1987.

What is claimed is:

1. A method of optimizing bitumen extraction from mined oil sand ores, using a process having one or more process variables which affect bitumen recovery and/or bitumen froth quality, the method comprising the steps of:
(a) measuring a measure of hydrophobicity of the solids in the ore; and
(b) adjusting the one or more process variables in response to the measure of hydrophobicity to increase bitumen recovery and/or improve bitumen froth quality by increasing its bitumen content and/or reducing its solids content.

2. The method as claimed in claim 1, further comprising:
(c) measuring ore grade, fines content, or both, of the ore and adjusting the one or more process variables in response to the measure of hydrophobicity and one or both of ore grade and fines content.

3. The method of claim 1, wherein the measure of hydrophobicity is the average hydrophobicity or a hydrophobicity distribution of solid particles in an ore sample.

4. The method of claim 2, wherein the measure of hydrophobicity is the average hydrophobicity or a hydrophobicity distribution of solid particles in an ore sample.

5. The method of claim 1 wherein the hydrophobicity measurement is performed online, inline, offline, or at-line at any suitable point in the process.

6. The method of claim 3 wherein the average hydrophobicity and the hydrophobicity distribution are determined by a thin film flotation test.

7. The method of claim 4, wherein the average hydrophobicity and the hydrophobicity distribution are determined by a thin film flotation test.

8. The method of claim 1, wherein the one or more process variable comprises target of ores for blending, blending ratio, caustic dosage, water addition, or processing temperature, or combinations thereof.

9. The method of claim 2, wherein the one or more process variable comprises target of ores for blending, blending ratio, caustic dosage, water addition, or processing temperature, or combinations thereof.

10. The method of claim 2, wherein the hydrophobicity measurement is performed online, inline, offline, or at-line at any suitable point in the process.
